(19) United States
(12) Patent Application Publication
(10) Pub. No.: US 2026/0364678 A1
(43) Pub. Date: Nov. 19, 2026

(54) MAGNETIC GRANULAR MATERIAL, MANUFACTURING METHOD OF THE SAME, AND MANUFACTURING METHOD OF RARE EARTH MAGNET

(71) Applicant: HONDA MOTOR CO., LTD., Tokyo (JP)

(72) Inventors: Akihito NINOMIYA, Saitama (JP); Ibuki OTA, Saitama (JP); Yasutaka SHINTANI, Saitama (JP)

(21) Appl. No.: 19/575,365

(22) Filed: Mar. 23, 2026

(30) Foreign Application Priority Data
Mar. 31, 2025 (JP) 2025-060056

(51) Int. Cl. B22F 1/16; B22F 1/068; B22F 1/102; B22F 1/145; B22F 3/14; B22F 3/16; H01F 1/06

(52) U.S. Cl. CPC B22F 1/16; B22F 1/068; B22F 1/102; B22F 1/145; B22F 3/14; B22F 3/16; H01F 1/061; B22F 2301/45; B22F 2302/45; B22F 2998/10; B22F 2999/00

(57) ABSTRACT

A magnetic granular material includes laminated flake-shaped rare earth magnetic powder particles and has a thickness of 0.15 mm or more and an insulating layer including fluoride nanoparticles having a particle diameter of 1 to 100 nm. Each rare earth magnetic powder particle has a major-axis length of 300 μm or more, and an average thickness of the rare earth magnetic powder particles is 10 μm to 30 μm. A manufacturing method of the magnetic granular material includes binding the rare earth magnetic powder particles to obtain the magnetic granular materials. A manufacturing method of a rare earth magnet includes: forming an insulating layer on the magnetic granular material to obtain the magnetic granular material; obtaining a primary molded product in which the magnetic granular materials are primarily molded; and performing hot plastic working on the primary molded product to obtain the rare earth magnet.

### TECHNICAL FIELD

The present invention relates to a magnetic granular material used as a material for a rare earth magnet, a manufacturing method of the same, and a manufacturing method of a rare earth magnet from the magnetic granular material.

### BACKGROUND ART

In recent years, efforts have been actively made to realize a low-carbon or decarbonized society, and research and development of electrification technology is being conducted for vehicles to reduce CO₂ emissions and improve energy efficiency. Methods for improving energy efficiency include improving the efficiency of motors used as power sources. In recent years, rare earth magnets have been widely used to improve motor efficiency. There is a need to improve magnetic properties of rare earth magnets. Since rare earth magnets are metallic magnets having low electrical resistivity, eddy current loss is likely to increase. Therefore, technologies for reducing eddy current loss in rare earth magnets have been proposed.

JP4784173B discloses a rare earth magnet capable of reducing eddy current losses, having rare earth magnetic powder particles, each covered with a film-like coating layer containing rare earth oxides. Bond portions containing rare earth oxide particles are interposed between the magnet powder particles coated with the rare earth oxides. A method of producing the rare earth magnet comprises conducting high-temperature pressure forming of a mixture of rare earth oxides and rare earth magnetic powder particles coated with the rare earth oxides.

JP2003-22905A discloses a manufacturing method of a rare earth magnet, comprising: mixing a magnet powder particles composed mainly of an alloy containing a Nd₂Fe₁₄B compound with one or more insulating compounds selected from oxide such as CaO, nitride such as BN, or fluoride such as CaF₂ for the purpose of increasing the electrical resistivity of the rare earth magnet; and processing the resulting mixture by hot plastic working to obtain an anisotropic magnetic material.

JP2010-27852A discloses that a first manufacturing method of a rare earth magnet comprises: preparing isotropic rapid-cooled powder particles such as Nd—Fe—B magnet powder particles; mixing the isotropic rapid-cooled powder particles with a predetermined compound for forming insulating layers; processing the mixture by cold molding to produce a cold molded product (temporary molding); processing the cold molded product by hot molding (densifying); and processing, by hot plastic molding, the resultant product (imparting anisotropy) to produce the rare earth magnet, and that a so-produced magnet includes generally stacked Nd—Fe—B rapid-cooled powder particles with the compound powder material interposed between, each particle having a long side length of 100 to 400 μm and a thickness of 20 to 40 μm.

In the rare earth magnet described in JP4784173B, an insulating material composed of dysprosium oxide (Dy₂O₃) is used as the rare earth oxide. Since dysprosium oxide has hygroscopicity, moisture adsorbed onto the dysprosium oxide may reduce the magnetic properties of the rare earth magnet. In the manufacturing method of the rare earth magnet described in JP2003-22905A, in the mixing process of mixing the Nd—Fe—B magnet powder particles with the insulating compound, the magnet powder particle is pulverized and excessively subdivided, which increases a specific surface area of the magnet powder particle and makes the magnet powder particle more susceptible to oxidation. Accordingly, oxidation of the rare earth magnet may cause a reduction in magnetic flux density of the rare earth magnet.

In the manufacturing method of the rare earth magnet described in JP2010-27852A, compound A, which is at least one compound selected from the group consisting of fluorides, oxides, and inorganic salts of heavy rare earth elements, is reacted with compound B, which is a hydride of an alkaline earth metal, during the hot forming and heat treatment step. Here, side reactions such as oxidation of the magnet, or the reaction between compound A and compound B not proceeding appropriately may result in a reduction in the magnetic properties of the manufactured rare earth magnet. Accordingly, there is a demand for a material for a rare earth magnet with reduced eddy current loss, and a rare earth magnet with reduced eddy current loss.

### SUMMARY OF THE INVENTION

In view of the above background, an object of the present invention is to provide a magnetic granular material used as a material for a rare earth magnet with reduced eddy current loss, a manufacturing method of the magnetic granular material, and a manufacturing method of the rare earth magnet from the magnetic granular materials, which consequently contributes to improving energy efficiency.

To achieve such an object, one aspect of the present invention provides a magnetic granular material used as a material for a rare earth magnet, the magnetic granular material comprising: a plurality of laminated flake-shaped rare earth magnetic powder particles; and an insulating layer having insulating properties and provided on a surface layer. The insulating layer includes a plurality of fluoride nanoparticles having a particle diameter of 1 to 100 nm, the fluoride nanoparticles being composed of a fluoride, and the fluoride is an alkali metal fluoride or an alkaline earth metal fluoride.

According to this aspect, it is possible to provide the magnetic granular material used as the material for the rare earth magnet with reduced eddy current loss.

Another aspect of the present invention provides a manufacturing method of the magnetic granular material, the method comprising: a binding step of binding the plurality of rare earth magnetic powder particles so as to be laminated to obtain a plurality of magnetic granular material precursors including the plurality of laminated rare earth magnetic powder particles; and an insulating layer forming step of spraying a nanoparticle dispersion liquid, in which the plurality of fluoride nanoparticles is dispersed, onto the plurality of magnetic granular material precursors that are being tumbled and fluidized, to obtain the magnetic granular material.

According to this aspect, it is possible to readily manufacture the magnetic granular materials.

Another aspect of the present invention provides a manufacturing method of a rare earth magnet from a plurality of magnetic granular materials, the method comprising: a primary molding step of arranging the plurality of magnetic granular materials so as to be laminated and molding the plurality of laminated magnetic granular materials to obtain a primary molded product in which the plurality of magnetic granular materials is primarily molded; and a hot plastic working step of performing hot plastic working on the primary molded product obtained in the primary molding step to obtain the rare earth magnet.

According to this aspect, it is possible to reliably manufacture the rare earth magnet with reduced eddy current loss.

Thus, according to the above aspects, it is possible to provide the magnetic granular material used as a material for the rare earth magnet with reduced eddy current loss, the manufacturing method of the magnetic granular material, and the manufacturing method of the rare earth magnet from the magnetic granular materials.

### BRIEF DESCRIPTION OF THE DRAWING(S)

FIG. 1 is a schematic cross-sectional view of a rare earth magnet according to an embodiment of the present invention;

FIG. 2 is a schematic cross-sectional view of a magnetic granular material according to the embodiment;

FIG. 3 is a diagram showing a manufacturing method of the rare earth magnet according to the embodiment;

FIG. 4 is a schematic diagram of a tumbling fluidized bed apparatus;

FIG. 5A is a diagram showing the difference in insulating layers depending on a proportion (wt %) of a binder compound contained in an insulating layer;

FIG. 5B is a diagram showing the difference in insulating layers depending on a proportion (wt %) of a binder compound contained in an insulating layer;

FIG. 5C is a diagram showing the difference in insulating layers depending on a proportion (wt %) of a binder compound contained in an insulating layer;

FIG. 6A is a diagram showing the difference in the insulating layer depending on a weight average molecular weight of the binder compound contained in the insulating layer;

FIG. 6B is a diagram showing the difference in the insulating layer depending on a weight average molecular weight of the binder compound contained in the insulating layer; and

FIG. 6C is a diagram showing the difference in the insulating layer depending on a weight average molecular weight of the binder compound contained in the insulating layer.

### DETAILED DESCRIPTION OF THE INVENTION

In the following, with reference to the drawings, a rare earth magnet 1 according to an embodiment of the present invention will be described in detail. In the following description, the numerical range “XX to YY” means “XX or more and YY or less” unless otherwise specified.

### Structure of the Rare Earth Magnet 1

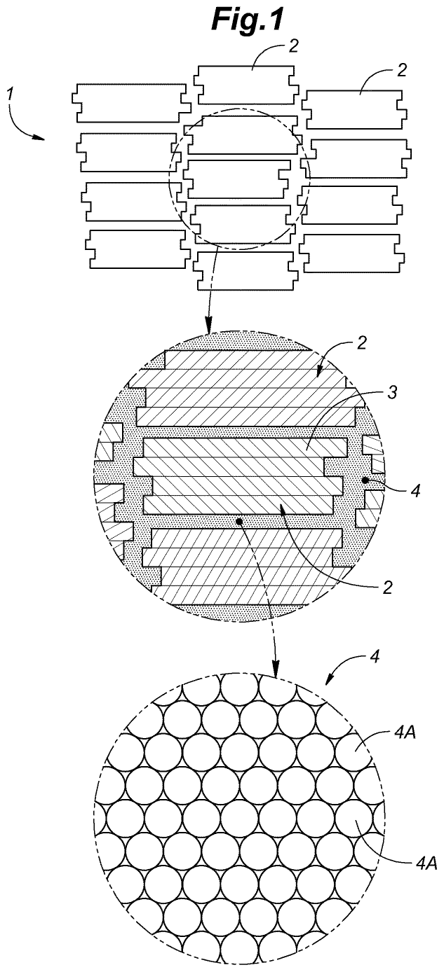

FIG. 1 is a schematic cross-sectional view of the rare earth magnet 1 according to the embodiment. As shown in FIG. 1, the rare earth magnet 1 includes a plurality of insulated magnetic granular materials 2, which may be insulated and arranged so as to be laminated. In an embodiment, each of the insulated magnetic granular materials 2 includes a plurality of laminated flake-shaped rare earth magnetic powder particles 3, and an insulating layer 4 formed on a surface layer of the insulated magnetic granular material 2 and having insulating properties. The insulating layer 4 covers an outer peripheral surface of the laminated rare earth magnetic powder particles 3.

The rare earth magnetic powder particle 3 is preferably a flake-shaped neodymium magnet (Nd—Fe—B magnet, more precisely Nd₂Fe₁₄B).

The insulating layer 4 includes a plurality of fluoride nanoparticles 4A made of a fluoride. The fluoride nanoparticles 4A are for example particles made of calcium fluoride (CaF₂). Calcium fluoride (CaF₂) has a melting point higher than that of the rare earth magnetic powder particles 3, and therefore exhibits low reactivity with the rare earth magnetic powder particles 3. The particle diameter of the fluoride nanoparticles 4A is preferably from 1 to 100 nm.

The fluoride nanoparticles 4A may be particles made of an inorganic fluorine compound having insulating properties. The fluoride nanoparticles 4A preferably have a melting point higher than that of the rare earth magnetic powder particle 3 and exhibit low reactivity with the rare earth magnetic powder particles 3. Since the fluoride nanoparticles 4A have a melting point higher than that of the rare earth magnetic powder particle 3 and exhibit low reactivity with the rare earth magnetic powder particle 3, the fluoride nanoparticles 4A are preferably nanoparticles made of an alkali metal fluoride such as lithium fluoride, or nanoparticles made of an alkaline earth metal fluoride such as magnesium fluoride, barium fluoride, or strontium fluoride. The insulating layer 4 may include, as the fluoride nanoparticles 4A, a plurality of nanoparticles made of an alkali metal fluoride and a plurality of nanoparticles made of an alkaline earth metal fluoride. The insulating layer 4 may also include, as the fluoride nanoparticles 4A, nanoparticles containing an alkali metal fluoride and an alkaline earth metal fluoride.

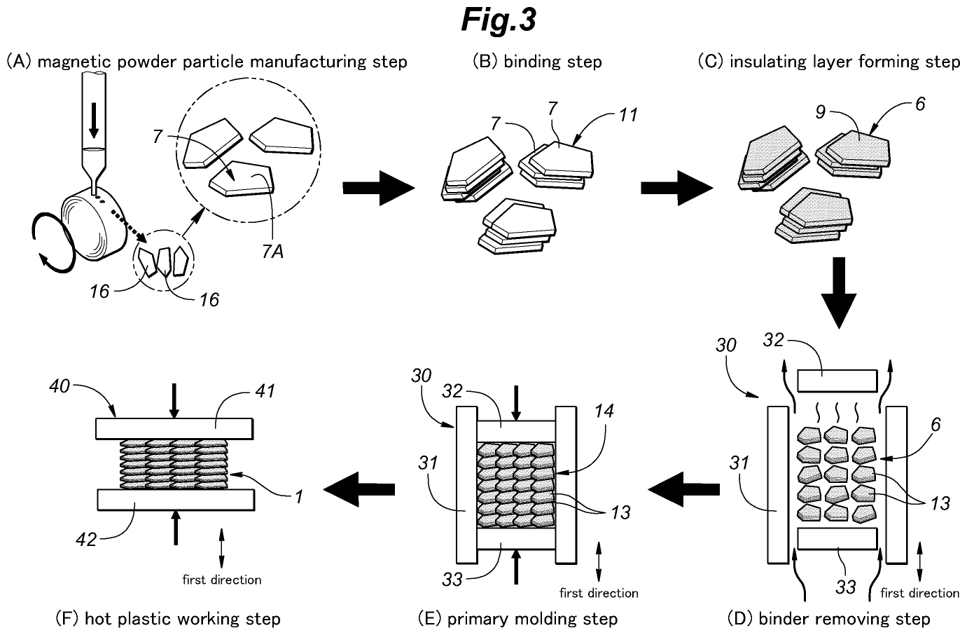

As will be described in detail later, in the manufacturing process of the rare earth magnet 1 (hot plastic working step (F) of FIG. 3), the rare earth magnetic powder particles 3 are heated, while pressure is being applied thereto in a direction (first direction) perpendicular to a main surface thereof. Accordingly, crystal grains in the magnet are shortened in the first direction (compression direction) and elongated in a direction perpendicular to the first direction (direction in which the main surface extends). The rare earth magnet 1 is magnetized in the first direction (compression direction). The crystal grains of the rare earth magnet 1 are oriented as described above, and the rare earth magnet 1 is magnetized as described above, thereby increasing the squareness ratio of the rare earth magnet 1 after magnetization.

As shown in FIG. 1, the rare earth magnet 1 is an aggregate of the insulated magnetic granular materials 2 each having the insulating layer 4 on the surface layer thereof. The rare earth magnet 1 includes the plurality of insulated magnetic granular materials 2 that are electrically isolated from each other by the insulating layers 4, thereby having a high electrical resistivity. This reduces the eddy current loss of the rare earth magnet 1. Accordingly, the rare earth magnet 1 has a suitable squareness ratio and reduced eddy current loss.

### Structure of Magnetic Granular Material 6

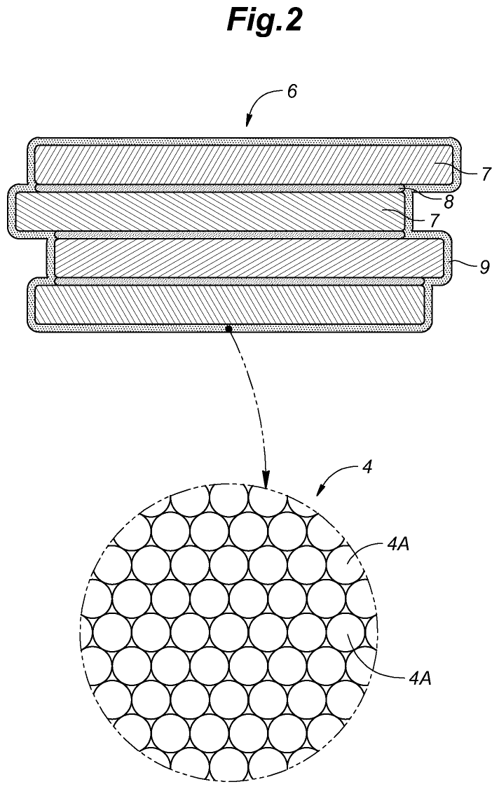

FIG. 2 is a schematic cross-sectional view of the magnetic granular material 6 according to the embodiment. The magnetic granular material 6 is a material of the rare earth magnet 1. As shown in FIG. 2, the magnetic granular material 6 includes a plurality of laminated flake-shaped rare earth magnetic powder particles 7 and a binder compound layer 8 that binds the rare earth magnetic powder particles 7, and an insulating layer 9 having insulating properties and provided on the surface layer.

The composition of the rare earth magnetic powder particle 7 is the same as that of the rare earth magnetic powder particle 3. The rare earth magnetic powder particle 7 is a flake-shaped rare earth magnet. The lower limit of a major-axis length of the rare earth magnetic powder particle 7 is 300 μm. The average thickness of the rare earth magnetic powder particles 7 is 10 μm to 30 μm. The rare earth magnetic powder particle 7 is preferably a flake-shaped neodymium magnet (Nd—Fe—B magnet, more precisely, Nd₂Fe₁₄B). The rare earth magnetic powder particle 7 has anisotropy but may have isotropy. Anisotropy refers to a property in which crystal orientations (easy magnetization axes, c-axes) are aligned in a specific direction. Isotropy refers to a property in which crystal orientations are not aligned in a specific direction.

The binder compound layer 8 is present between adjacent rare earth magnetic powder particles 7 and binds the adjacent rare earth magnetic powder particles 7 to each other. The binder compound layer 8 includes a binder compound. The binder compound is preferably, in one embodiment, an acrylic polymer having a weight average molecular weight greater than 100,000 and not more than 300,000. The acrylic polymer is thermally decomposable at a temperature lower than the melting point of the rare earth magnetic powder particles 7.

The binder compound may be any compound that can bind the rare earth magnetic powder particles 7. The binder compound does not necessarily have a weight average molecular weight greater than 100,000 and not more than 300,000. The binder compound is preferably, in one embodiment, an acrylic polymer. The binder compound is preferably a resin.

The insulating layer 9 includes the binder compound and the plurality of fluoride nanoparticles 4A made of a fluoride. The fluoride nanoparticles 4A are particles made of calcium fluoride (CaF₂) and have a particle diameter of 1 to 100 nm. As described above, the fluoride nanoparticles 4A may be particles made of an insulating inorganic fluorine compound having insulating properties. The fluoride nanoparticles 4A preferably have a melting point higher than that of the rare earth magnetic powder particles 3 and exhibit low reactivity with the rare earth magnetic powder particles 3. The fluoride nanoparticles 4A are preferably nanoparticles made of an alkali metal fluoride, such as lithium fluoride, or nanoparticles made of an alkaline earth metal fluoride, such as magnesium fluoride, barium fluoride, or strontium fluoride. The insulating layer 9 may include, as the fluoride nanoparticles 4A, a plurality of nanoparticles made of an alkali metal fluoride and a plurality of nanoparticles made of an alkaline earth metal fluoride. The insulating layer 9 may also include, as the fluoride nanoparticles 4A, nanoparticles containing an alkali metal fluoride and an alkaline earth metal fluoride.

### Manufacturing Method of the Rare Earth Magnet 1

FIG. 3 is a diagram showing the manufacturing method of the rare earth magnet 1. As shown in FIG. 3, the manufacturing method of the rare earth magnet 1 includes a magnetic powder particle manufacturing step (A) of manufacturing the rare earth magnetic powder particles 7; a binding step (B) of binding the rare earth magnetic powder particles 7 so as to be laminated to obtain the magnetic granular material precursors 11; an insulating layer forming step (C) of forming an insulating layer 9 on a surface of each of the magnetic granular material precursors 11 to obtain the magnetic granular materials 6; a binder removing step (D) of removing the binder compound contained in the magnetic granular materials 6 by thermal decomposition to obtain degreased magnetic granular materials 13; the primary molding step (E) of obtaining a primary molded product 14 by primary molding the degreased magnetic granular materials 13; and a hot plastic working step (F) of performing hot plastic working on the primary molded product 14 to obtain the rare earth magnet 1.

The magnetic powder particle manufacturing step (A) is a step for manufacturing the flake-shaped rare earth magnetic powder particles 7 having a predetermined size. A melt spinning technique is preferably used in the magnetic powder particle manufacturing step (A). As shown in step (A) of FIG. 3, the melt spinning technique is a technique of obtaining a thin plate-shaped magnet by spraying a rare earth magnet heated to a molten state onto a roll and cooling the sprayed rare earth magnet. The composition of the rare earth magnet to be melted is the same as the composition of the rare earth magnetic powder particle 3. The thin plate-shaped magnet is then pulverized to obtain small magnet pieces 16. Then, the rare earth magnetic powder particles 7 are obtained by classifying the rare earth magnetic powder particles 7 from the small magnet pieces 16. It should be noted that the melt spinning technique does not necessarily have to be used in the magnetic powder particle manufacturing step (A). The magnetic powder particle manufacturing step (A) may be a step of pulverizing a thin plate-shaped rare earth magnet to obtain the rare earth magnetic powder particles 7.

The rare earth magnetic powder particle 7 becomes more likely to crack as the thickness decreases. The lower limit of the major-axis length of the rare earth magnetic powder particle 7 is 300 μm, and the average thickness of the rare earth magnetic powder particles 7 is 10 μm to 30 μm. Further, the average thickness of the rare earth magnetic powder particles 7 is preferably 20 μm.

The rare earth magnetic powder particle 7 has a flake shape and includes a pair of main surfaces 7A. The main surfaces 7A are the largest pair of surfaces among a pair of flat surfaces facing opposite directions. The rare earth magnetic powder particle 7 may have an aspect ratio of approximately 1 (for example, 0.7 to 1.0) when viewed from a direction perpendicular to the main surfaces 7A. The aspect ratio is the ratio of the minor diameter b (minor-axis length) to a major diameter a (major-axis length) of a particle (aspect ratio=minor diameter b/major diameter a). Here, the major diameter a (major-axis length) means a maximum Feret diameter, and the minor diameter b (minor-axis length) means a minimum Feret diameter. The method for measuring the major diameter and the minor diameter complies with the provisions of JIS Z8890:2017 “Particle characterization of particulate systems.”

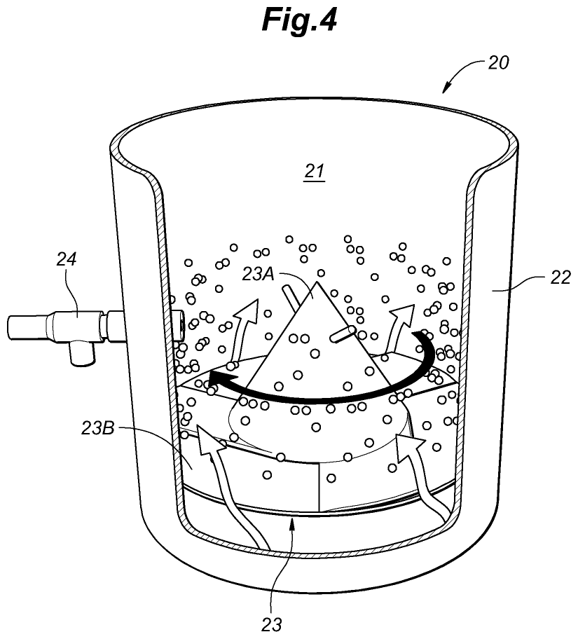

The binding step (B) is a step of binding the plurality of rare earth magnetic powder particles 7 so as to be laminated by the binder compound to obtain the magnetic granular material precursors 11. In the binding step (B), the binder compound solution may be sprayed onto the rare earth magnetic powder particles 7 that are being tumbled and fluidized using a tumbling fluidized bed apparatus 20 (see FIG. 4), and the plurality of rare earth magnetic powder particles 7 is bound so as to be laminated by the binder compound.

The binder compound solution is, for example, a solution containing 4 wt % of the binder compound. The solvent of the binder compound solution is preferably 2-propanol (also referred to as “isopropyl alcohol” or “IPA”), but is not limited thereto. The solvent of the binder compound solution is preferably alcohol. To allow the solvent to be readily evaporated after the rare earth magnetic powder particles 7 are bound so as to be laminated, the solvent of the binder compound solution is preferably a solvent that readily evaporates at room temperature.

FIG. 4 is a schematic diagram of the tumbling fluidized bed apparatus 20. As shown in FIG. 4, the tumbling fluidized bed apparatus 20 includes a body housing 22 having a fluidized bed 21 therein for tumbling and fluidizing the rare earth magnetic powder particles 7, a rotatable blade rotor 23 that defines the bottom of the fluidized bed 21, a spray nozzle 24 provided on the side of the body housing 22, and an air blower (not shown) that transmits a swirling air flow to the fluidized bed 21 through a gap between the outer circumference of the blade rotor 23 and the body housing 22. The blade rotor 23 includes a conical portion 23A that protrudes upward at a central portion thereof, and stirring blades 23B that protrude upward and extend radially. The spray nozzle 24 is attached to the body housing 22 to spray the binder compound solution toward the lower portion of the fluidized bed 21.

In the binding step (B), the rare earth magnetic powder particles 7 are introduced into the fluidized bed 21. The blade rotor 23 is then rotated, and the air blower generates a swirling air flow within the fluidized bed 21. As a result, the rare earth magnetic powder particles 7 in the fluidized bed 21 are tumbled and fluidized. In this state, the binder compound solution is sprayed from the spray nozzle 24 onto the rare earth magnetic powder particles 7 that are being tumbled and fluidized. Here, to properly bind the rare earth magnetic powder particles 7, the binder compound solution is preferably sprayed at a rate of not less than 5 g/min and not more than 30 g/min per 1 kg of the rare earth magnetic powder particles 7 that are being tumbled and fluidized.

The rare earth magnetic powder particles 7 are bound by the sprayed binder compound solution. Here, the binder compound solution binds the main surfaces 7A of the adjacent rare earth magnetic powder particles 7. The solvent (IPA) evaporates from the binder compound solution that binds the rare earth magnetic powder particles 7. Accordingly, the magnetic granular material precursor 11 is obtained in which the plurality of rare earth magnetic powder particles 7 are bound so as to be laminated by the binder compound. Here, the phrase “being bound so as to be laminated” means that a plurality of rare earth magnetic powder particles 7 are bound with the main surfaces 7A thereof facing in the same direction. The magnetic granular material precursor 11 includes the laminated flake-shaped rare earth magnetic powder particles 7. The term “laminated flake-shaped rare earth magnetic powder particles 7” means a plurality of rare earth magnetic powder particles 7 laminated with the main surfaces 7A thereof facing in the same direction.

In the magnetic granular material precursor 11, the binder compound solution that binds the rare earth magnetic powder particles 7 is dried. The magnetic granular material precursor 11 preferably contains 0.5 to 2.5 wt % of the binder compound. The concentration of the binder compound in the binder compound solution and the injection amount of the binder compound solution are set so that the magnetic granular material precursor 11 contains 0.5 to 2.5 wt % of the binder compound. To ensure that the rare earth magnet 1 manufactured from the magnetic granular material precursor 11 has favorable magnetic properties, the thickness of the magnetic granular material precursor 11 in a lamination direction of the rare earth magnetic powder particles 7 is preferably 0.15 mm or more and 1 mm or less.

As shown in FIG. 3, the insulating layer forming step (C) is a step of forming the insulating layer 9 having insulating properties on the surface layer of each of the magnetic granular material precursors 11 to obtain the magnetic granular materials 6. The magnetic granular material 6 is a powder particle obtained by forming the insulating layer 9 on the magnetic granular material precursor 11. In the insulating layer forming step (C), using the tumbling fluidized bed apparatus 20, a nanoparticle dispersion liquid containing the plurality of fluoride nanoparticles 4A is sprayed onto the magnetic granular material precursors 11 that are being tumbled and fluidized, thereby forming the insulating layer 9 on the surface layer of the magnetic granular material precursors 11. As described above, the fluoride nanoparticles 4A according to the present embodiment are nanoparticles made of calcium fluoride (CaF₂) and have a particle diameter of 1 to 100 nm.

The nanoparticle dispersion liquid contains, for example, 4 wt % of the fluoride nanoparticles 4A and 2.5 wt % of the binder compound. Accordingly, the insulating layer 9 formed by drying the nanoparticle dispersion liquid contains 38 wt % of the binder compound and 62 wt % of the fluoride nanoparticles 4A.

The solvent of the nanoparticle dispersion liquid is preferably 2-propanol (IPA). The binder compound is a compound capable of binding the fluoride nanoparticles 4A, and is preferably the same compound as the binder compound used in the binding step (B). The fluoride nanoparticles 4A are dispersed in the nanoparticle dispersion liquid. The concentrations of the fluoride nanoparticles 4A and the binder compound in the nanoparticle dispersion liquid, as well as the solvent, may be changed.

In the insulating layer forming step (C), as shown in FIG. 4, the magnetic granular material precursors 11 are introduced into the fluidized bed 21 of the tumbling fluidized bed apparatus 20. The blade rotor 23 is then rotated, and the air blower generates a swirling air flow within the fluidized bed 21. As a result, the magnetic granular material precursors 11 in the fluidized bed 21 are tumbled and fluidized. In this state, the nanoparticle dispersion liquid is sprayed from the spray nozzle 24 onto the magnetic granular material precursors 11 that are being tumbled and fluidized. The sprayed nanoparticle dispersion liquid adheres to the surfaces of the magnetic granular material precursors 11 and is dried. Accordingly, the insulating layer 9 is formed on the surface layers of the magnetic granular material precursors 11, and the magnetic granular materials 6 are obtained.

The insulating layer 9 formed as described above preferably contains the plurality of fluoride nanoparticles 4A made of a fluoride and having a particle diameter of 1 to 100 nm, and is formed to contain 20 wt % or more of the binder compound that binds the plurality of fluoride nanoparticles 4A.

The binder removing step (D) is a step of heating the magnetic granular materials 6 to a temperature equal to or higher than the thermal decomposition temperature of the binder compound to thermally decompose the binder compound, thereby obtaining the degreased magnetic granular materials 13 from which the binder compound has been removed.

In the binder removing step (D), the magnetic granular materials 6 may be heated within the mold of a hot press machine. As shown in step (D) of FIG. 3, a mold 30 of the hot press machine includes a cylindrical mold body 31, and an upper mold 32 and a lower mold 33 capable of applying a compressive force in a first direction to an object within the mold body 31. In FIG. 3, the first direction is the up-and-down direction, but the first direction may be a direction other than the up-and-down direction.

In the binder removing step (D), the magnetic granular materials 6 arranged within the mold body 31 of the mold 30 are heated, without pressure being applied by the mold 30 (the upper mold 32 and the lower mold 33), to a temperature equal to or higher than the thermal decomposition temperature of the binder compound (for example, 300 °C to 400 °C) for the predetermined period (for example, 2 to 4 hours) in a reduced pressure environment or in an inert gas flow. The inert gas is a gas having low reactivity with the rare earth magnetic powder particles 7. The inert gas is preferably, for example, a noble gas. The inert gas is preferably helium gas. Air may be used when oxidation is not a concern or under controlled conditions.

The products generated by thermal decomposition of the binder compound are discharged to the outside of the mold 30. The binder compound is preferably an acrylic polymer (polymethyl methacrylate) having a weight average molecular weight greater than 100,000 and not more than 300,000. The acrylic polymer is thermally decomposed into the methyl methacrylate monomer. The decomposition products generated by the thermal decomposition of the binder compound volatilize and are discharged to the outside of the mold 30.

When the magnetic granular materials 6 are heated in the reduced pressure environment in the binder removing step (D), the magnetic granular materials 6 are heated within the mold body 31 (the mold 30) in the reduced pressure environment. In this case, the decomposition products of the binder compound (for example, the methyl methacrylate monomer) are more likely to volatilize since the decomposition products are arranged in the reduced pressure environment, and are more readily discharged to the outside of the mold body 31 (the mold 30). Further, the decomposition products of the binder compound are less likely to remain around the magnetic granular materials 6 and less likely to react with the rare earth magnetic powder particles 7, thereby suppressing deterioration of the rare earth magnetic powder particles 7.

When the magnetic granular materials 6 are heated in an inert gas flow, the magnetic granular materials 6 are heated while the inert gas is flowing inside the mold body 31 (the mold 30). This allows the decomposition products of the binder compound (for example, the methyl methacrylate monomer) to be readily discharged to the outside of the mold body 31 (the mold 30) by the inert gas flow. Further, the decomposition products of the binder compound are less likely to remain around the magnetic granular materials 6 and less likely to react with the rare earth magnetic powder particle 7, thereby suppressing deterioration of the rare earth magnetic powder particle 7. It is preferable that the inert gas be heated to a temperature equal to or higher than the thermal decomposition temperature of the binder compound before the inert gas is introduced into the mold 30. This allows the binder compound to be heated by the inert gas, thereby promoting the thermal decomposition of the binder compound.

The primary molding step (E) is a step of obtaining the primary molded product 14 by applying pressure to a plurality of degreased magnetic granular materials 13. The mold 30 may be used in the primary molding step (E). The primary molding step (E) is a step of obtaining the primary molded product 14 by primary molding the degreased magnetic granular materials 13 obtained by removing the binder compound from the magnetic granular materials 6. The primary molding step (E) may be considered as a type of step in which the plurality of magnetic granular materials 6 obtained in the insulating layer forming step (C) are arranged so as to be laminated and primarily molded to obtain the primary molded product 14 in which the plurality of magnetic granular materials 6 is primarily molded.

The primary molding step (E) may be a step of performing hot forming (primary molding) in which the degreased magnetic granular materials 13 are heated to the predetermined temperature within the mold 30, and the predetermined pressure is applied for the predetermined period. Here, hot forming may be performed at a mold temperature of 600 °C to 700 °C, preferably about 640 °C. When pressure is applied to the degreased magnetic granular materials 13 within the mold 30, the plurality of degreased magnetic granular materials 13 is oriented so that the main surfaces 7A of the rare earth magnetic powder particles 7 contained in the degreased magnetic granular materials 13 face the first direction, and are laminated in a direction (the first direction) perpendicular to the main surfaces 7A. Accordingly, by hot forming, the plurality of degreased magnetic granular materials 13 is compressed and deformed while being laminated in a direction (the first direction) perpendicular to the main surfaces of the degreased magnetic granular materials 13 (the main surfaces 7A of the rare earth magnetic powder particles 7).

The hot plastic working step (F) is a step of performing hot plastic working on the primary molded product 14 obtained in the primary molding step (E) to obtain the rare earth magnet 1. The hot plastic working step (F) includes heating the primary molded product 14 to a temperature at which a part of the crystal grains of the rare earth magnetic powder particle 7 undergoes a phase transition to a liquid phase (melting point of the rare earth magnetic powder particle 7, for example, about 850 °C), while applying pressure, thereby plastically deforming the primary molded product 14.

The hot plastic working step (F) is performed using a second mold 40. The second mold 40 has an upper pressing die 41 and a lower pressing die 42 arranged opposite to each other. The primary molded product 14 is arranged within the second mold 40 such that pressure is applied to the plurality of degreased magnetic granular materials 13 contained in the primary molded product 14 in a direction (first direction) perpendicular to the main surfaces 7A. During plastic deformation of the primary molded product 14, the crystal grains of the rare earth magnetic powder particles 7 contained in the primary molded product 14 are oriented such that a c-axis direction (an easy magnetization direction) of the crystal grains is parallel to the first direction (the compression direction). Accordingly, magnetic anisotropy (uniaxial anisotropy) is developed in the primary molded product 14 during the plastic deformation. The rare earth magnetic powder particles 3 contained in the rare earth magnet 1 are obtained by plastically deforming the rare earth magnetic powder particles 7 such that the crystal grains are oriented in the first direction (the compression direction). The rare earth magnet 1 obtained in the hot plastic working step (see FIG. 1) is magnetized in the direction (first direction) in which the magnetic anisotropy is developed.

In the hot plastic working step (F), the degreased magnetic granular materials 13 are heated, while pressure is being applied thereto in a direction (first direction) perpendicular to the main surfaces of the degreased magnetic granular materials 13. Accordingly, the crystal grains in the magnet are shortened in the first direction (the compression direction) and elongated in a direction perpendicular to the first direction (the direction in which the main surface extends). The rare earth magnet 1 is magnetized in the first direction (the compression direction). The crystal grains of the rare earth magnet 1 are oriented as described above, and the rare earth magnet 1 is magnetized as described above, thereby increasing the squareness ratio of the rare earth magnet 1.

As shown in FIG. 1, the rare earth magnet 1 is an aggregate of the insulated magnetic granular materials 2 each having the insulating layer 4 on the surface layer thereof, and has high electrical resistivity due to the insulating layer 4. This reduces the eddy current loss of the rare earth magnet 1. Accordingly, the rare earth magnet 1 has a suitable squareness ratio and reduced eddy current loss.

Next, the effects of the rare earth magnet 1 manufactured in this manner and the manufacturing method thereof will be described.

The magnetic granular material 6 includes the plurality of laminated flake-shaped rare earth magnetic powder particles 7 and an insulating layer 9 having insulating properties and provided on the surface layer. The insulating layer 9 includes the plurality of fluoride nanoparticles 4A composed of fluoride and having a particle diameter of 1 to 100 nm, and the fluoride contained in the fluoride nanoparticles 4A is an alkali metal fluoride or an alkaline earth metal fluoride.

Alkali metal fluorides and alkaline earth metal fluorides generally exhibit low reactivity with the rare earth magnetic powder particles 3. Accordingly, a reaction between the insulating layer 9 and the rare earth magnet 1 (the rare earth magnetic powder particles 7) is suppressed, thereby suppressing deterioration of the magnetic granular material 6. Further, during the process of manufacturing the rare earth magnet 1 from the magnetic granular materials 6, the insulating layer 9 protects the rare earth magnetic powder particles 7, thereby suppressing deterioration of the rare earth magnetic powder particles 7.

The fluoride nanoparticles 4A have a particle diameter of 1 to 100 nm, and the insulating layer 9 includes the plurality of fluoride nanoparticles 4A. Accordingly, the fluoride nanoparticles 4A flow within the insulating layer 9, allowing the insulating layer 9 to be readily deformed. For example, when the insulating layer 9 is compressed, the insulating layer 9 can readily expand. This prevents cracking of the insulating layer 9 and electrical conduction between adjacent magnetic granular materials 6, so that the insulating layer 9 can reliably increase the electrical resistivity of the rare earth magnet 1 manufactured from the magnetic granular materials 6. Accordingly, it is possible to provide the magnetic granular material 6 used as a material for the rare earth magnet with reduced eddy current loss.

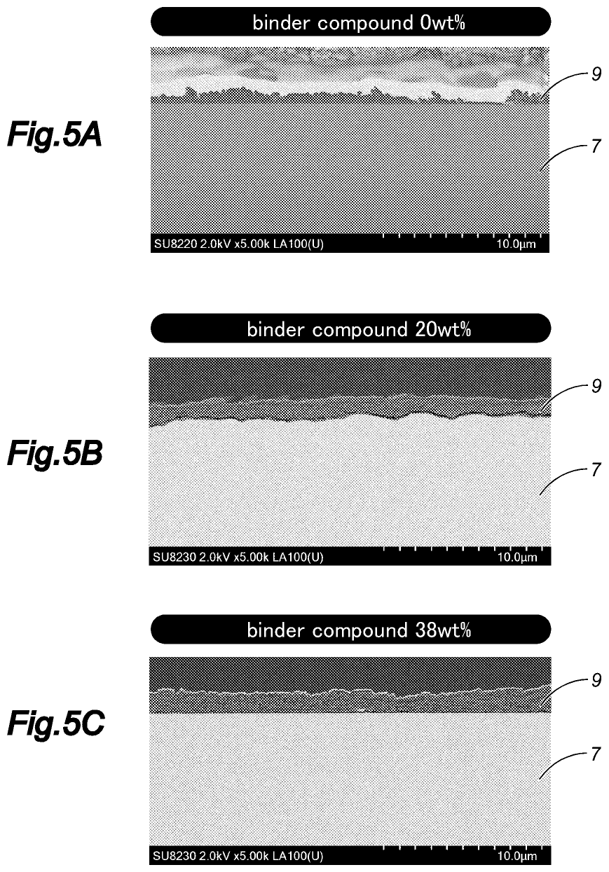

The insulating layer 9 contains 20 wt % or more of the binder compound that binds the fluoride nanoparticles 4A. FIGS. 5A to 5C are diagrams showing the differences in the insulating layer 9 depending on the proportion (wt %) of the binder compound contained in the insulating layer 9. FIG. 5A is a scanning electron micrograph (SEM) of the insulating layer 9 containing no binder compound. FIG. 5B is a scanning electron micrograph (SEM) of the insulating layer 9 containing 20 wt % of the binder compound. FIG. 5C is a scanning electron micrograph (SEM) of the insulating layer 9 containing 38 wt % of the binder compound.

As shown in FIG. 5A, when the insulating layer 9 does not contain the binder compound, variation in thickness occurs in the insulating layer 9, and the thickness of the insulating layer 9 is insufficient. Accordingly, it is not preferable that the insulating layer 9 does not contain the binder compound. As shown in FIG. 5B, when the insulating layer 9 contains 20 wt % of the binder compound, the insulating layer 9 has a sufficient thickness, and the variation in thickness is sufficiently small. Accordingly, it is preferable that the insulating layer 9 contains 20 wt % of the binder compound. As shown in FIG. 5C, when the insulating layer 9 contains 38 wt % of the binder compound, the insulating layer 9 has a sufficient thickness, and the variation in thickness is sufficiently small. Accordingly, it is preferable that the insulating layer 9 contains 38 wt % of the binder compound. Therefore, when the insulating layer 9 contains 20 wt % or more of the binder compound, the insulating layer 9 tends to have sufficiently small variation in thickness and an appropriate thickness.

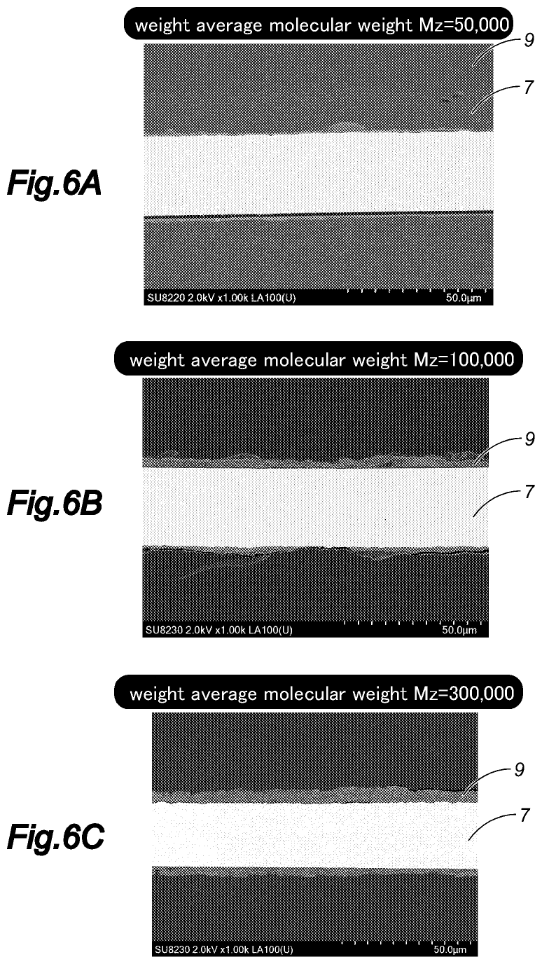

The weight average molecular weight of the binder compound contained in the insulating layer 9 is equal to or more than 100,000 and equal to or less than 300,000. FIGS. 6A to 6C are diagrams showing the differences in the insulating layer 9 depending on differences in the weight average molecular weight of the binder compound contained in the insulating layer 9. FIG. 6A is a scanning electron micrograph (SEM) of the insulating layer 9 containing the binder compound having a weight average molecular weight of 50,000. FIG. 6B is a scanning electron micrograph (SEM) of the insulating layer 9 containing the binder compound having a weight average molecular weight of 100,000. FIG. 6C is a scanning electron micrograph (SEM) of the insulating layer 9 when the nanoparticle dispersion liquid and the insulating layer 9 contain the binder compound having a weight average molecular weight of 300,000.

As shown in FIG. 6A, when the binder compound has a weight average molecular weight of 50,000, adhesion of the binder compound is weak, and variation in thickness occurs in the insulating layer 9, and the thickness of the insulating layer 9 is insufficient. Accordingly, the binder compound having a weight average molecular weight of 50,000 is not preferable. As shown in FIG. 6B, when the binder compound has a weight average molecular weight of 100,000, adhesion of the binder compound is sufficiently strong, and the insulating layer 9 has a sufficient thickness, and the variation in thickness is sufficiently small. Accordingly, the binder compound having a weight average molecular weight of 100,000 is preferable. As shown in FIG. 6C, when the binder compound has a weight average molecular weight of 300,000, adhesion of the binder compound is sufficiently strong, and the insulating layer 9 has a sufficient thickness, and the variation in thickness is sufficiently small. Accordingly, the binder compound having a weight average molecular weight of 300,000 is preferable.

As described above, when the binder compound contained in the nanoparticle dispersion liquid and the insulating layer 9 has a weight average molecular weight of 100,000 or more and 300,000 or less, the insulating layer 9 tends to have sufficiently small variation in thickness and an appropriate thickness.

The binder compound is thermally decomposable at a temperature lower than the melting point of the rare earth magnetic powder particles 7. This makes it easier to remove the binder compound from the magnetic granular materials 6 during the manufacturing process of the rare earth magnet 1 from the magnetic granular materials 6.

The binder compound is an acrylic polymer. Therefore, during the manufacturing process of the rare earth magnet 1 from the magnetic granular material 6, the binder compound can be readily thermally decomposed and removed, and the binder compound can be thermally decomposed without leaving residual components.

The manufacturing method of the magnetic granular material 6 includes the binding step (B) of obtaining the magnetic granular material precursor 11 including the plurality of laminated rare earth magnetic powder particles 7, and the insulating layer 9 forming step (C) of spraying the nanoparticle dispersion liquid, in which the plurality of fluoride nanoparticles 4A is dispersed, onto the plurality of magnetic granular material precursors 11 that are being tumbled and fluidized, to obtain the magnetic granular material 6. Accordingly, it is possible to readily manufacture the magnetic granular materials 6.

The manufacturing method of the rare earth magnet from the magnetic granular materials 6 includes the primary molding step (E) of obtaining the primary molded product 14 in which the plurality of magnetic granular materials 6 is primarily molded, and the hot plastic working step (F) of performing hot plastic working on the primary molded product 14 to obtain the rare earth magnet 1. Accordingly, it is possible to reliably manufacture the rare earth magnet 1 with reduced eddy current loss.

This concludes the description of the specific embodiment, but the present invention is not limited to the above embodiment and can be widely modified and implemented. For example, the solvent of the binder compound solution and the nanoparticle dispersion liquid is not limited to IPA, and may be an alcohol that is liquid at room temperature, such as 1-propanol or butanol.

The above embodiment may also be described as follows.

One embodiment is a magnetic granular material 6 used as a material for a rare earth magnet 1, the magnetic granular material comprising: a plurality of laminated flake-shaped rare earth magnetic powder particles 7; and an insulating layer 9 having insulating properties and provided on a surface layer of the magnetic granular material 6. The insulating layer 9 includes a plurality of fluoride nanoparticles 4A having a particle diameter of 1 to 100 nm, the fluoride nanoparticles being composed of a fluoride, and the fluoride contained in the fluoride nanoparticles 4A is an alkali metal fluoride or an alkaline earth metal fluoride.

According to this aspect, it is possible to provide the magnetic granular materials 6 used as a material for the rare earth magnet 1 with reduced eddy current loss.

In one embodiment, the insulating layer 9 includes 20 wt % or more of a binder compound that binds the plurality of fluoride nanoparticles 4A.

According to this aspect, the insulating layer 9 tends to have sufficiently small variation in thickness and an appropriate thickness.

In one embodiment, the binder compound contained in the insulating layer 9 has a weight average molecular weight of 100,000 or more and 300,000 or less.

According to this aspect, the insulating layer 9 tends to have sufficiently small variation in thickness and an appropriate thickness.

In one embodiment, the binder compound contained in the insulating layer 9 is thermally decomposable at a temperature lower than the melting point of the rare earth magnetic powder particles.

According to this aspect, during the manufacturing process of the rare earth magnet 1 from the magnetic granular materials 6, the binder compound can be readily removed from the magnetic granular materials 6.

In one embodiment, the magnetic granular material 6 includes a binder compound that binds the plurality of rare earth magnetic powder particles 7, and the binder compound is an acrylic polymer.

According to this aspect, during the manufacturing process of the rare earth magnet 1 from the magnetic granular material 6, the binder compound can be readily thermally decomposed and removed, and the binder compound can be thermally decomposed without leaving residual components.

One embodiment is a manufacturing method of the magnetic granular material 6, the method comprising: a binding step (B) of binding the plurality of rare earth magnetic powder particles 7 so as to be laminated to obtain a plurality of magnetic granular material precursors 11 including the plurality of laminated rare earth magnetic powder particles 7; and an insulating layer forming step (C) of spraying a nanoparticle dispersion solution, in which the plurality of fluoride nanoparticles 4A is dispersed, onto the plurality of magnetic granular material precursors 11 that are being tumbled and fluidized, to obtain the magnetic granular material 6.

According to this aspect, it is possible to readily manufacture the magnetic granular material 6.

One embodiment is a manufacturing method of a rare earth magnet 1, the method comprising; a primary molding step (E) of arranging the plurality of magnetic granular materials 6 so as to be laminated to obtain a primary molded product 14 in which the plurality of magnetic granular materials 6 is primarily molded; and a hot plastic working step (F) of performing hot plastic working on the primary molded product 14 obtained in the primary molding step (E) to obtain the rare earth magnet 1.

According to this aspect, it is possible to reliably manufacture the rare earth magnet 1 with reduced eddy current loss.

1. A magnetic granular material used as a material for a rare earth magnet, the magnetic granular material comprising:
a plurality of laminated flake-shaped rare earth magnetic powder particles; and
an insulating layer having insulating properties and provided on a surface layer, wherein
the insulating layer includes a plurality of fluoride nanoparticles having a particle diameter of 1 to 100 nm, the fluoride nanoparticles being composed of a fluoride, and
the fluoride is an alkali metal fluoride or an alkaline earth metal fluoride.

2. The magnetic granular material according to claim 1, wherein the insulating layer includes 20 wt % or more of a binder compound that binds the plurality of fluoride nanoparticles.

3. The magnetic granular material according to claim 2, wherein the binder compound has a weight average molecular weight of 100,000 or more and 300,000 or less.

4. The magnetic granular material according to claim 2, wherein the binder compound is thermally decomposable at a temperature lower than the melting point of the rare earth magnetic powder particles.

5. The magnetic granular material according to claim 2, wherein the binder compound is an acrylic polymer.

6. A manufacturing method of the magnetic granular material according to claim 1, the method comprising:
a binding step of binding the plurality of rare earth magnetic powder particles so as to be laminated to obtain a plurality of magnetic granular material precursors including the plurality of laminated rare earth magnetic powder particles; and
an insulating layer forming step of spraying a nanoparticle dispersion liquid, in which the plurality of fluoride nanoparticles is dispersed, onto the plurality of magnetic granular material precursors that are being tumbled and fluidized, to obtain the magnetic granular material.

7. A manufacturing method of a rare earth magnet from a plurality of magnetic granular materials according to claim 1, the method comprising:
a primary molding step of arranging the plurality of magnetic granular materials so as to be laminated to obtain a primary molded product in which the plurality of magnetic granular materials is primarily molded; and
a hot plastic working step of performing hot plastic working on the primary molded product obtained in the primary molding step to obtain the rare earth magnet.
